(19) United States
(12) Patent Application Publication
(10) Pub. No.: US 2009/0099305 A1
(43) Pub. Date: Apr. 16, 2009

(54) PROCESS FOR THE PREPARATION OF AN AQUEOUS COPOLYMER DISPERSION

(75) Inventors: Marc Schroder, Heidelberg (DE); Andreas Eipper, Ludwigshafen (DE); Matthias Scheibitz, Weinheim (DE); Jens Assmann, Mannheim (DE); Hiroki Fukuhara, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/298,152

(22) PCT Filed: Apr. 16, 2007
(86) PCT No.: PCT/EP07/53673

§ 371 Date: Oct. 23, 2008

(30) Foreign Application Priority Data
Apr. 27, 2006 (DE) 102006020275.9

(51) Int. Cl. C08F 222/00; C08L 33/00; C08L 35/00; C08F 120/00

(52) U.S. Cl. 524/804; 524/832; 526/72; 526/303.1; 526/306; 526/317.1; 526/318.2; 524/833; 524/827

(57) ABSTRACT

Process for preparing an aqueous copolymer dispersion, with specific crosslinker metering.

The present invention provides a process for preparing an aqueous copolymer dispersion by free-radically initiated aqueous emulsion polymerization of ethylenically unsaturated monomers in the presence of at least one dispersant and at least one free-radical initiator by the feed method, which comprises using for the emulsion polymerization

| | |
|---|---|
| 70% to 99.5% | α,β-monoethylenically unsaturated compounds |
| by weight | [monomers A], and |
| 0.5 to 30% | compounds having at least two free-radically |
| by weight | copolymerizable ethylenically unsaturated groups |
| | [monomers B], and also, if appropriate, |
| up to 5% | α,β-monoethylenically unsaturated monocarboxylic or |
| by weight | dicarboxylic acids having 3 to 6 C atoms and/or their |
| | amides [monomers C], |

the monomers A to C adding up to 100% by weight (total monomer amount) and the monomer feeds being made such that ≧60% by weight of the total amount of monomers B is metered into the polymerization mixture under polymerization conditions at a time when ≧60% by weight of the total monomer amount has been metered in under polymerization conditions to the polymerization mixture.

The present invention likewise provides the aqueous copolymer dispersions obtainable by the process of the invention, and their use in various fields of deployment.

The implementation of free-radically initiated emulsion polymerizations of ethylenically unsaturated monomers in an aqueous medium has been described on numerous previous occasions and is therefore adequately known to the skilled worker [cf. in this context Emulsion polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Inter-science Publishers, New York (1965); DE-A 40 03 422, and Dispersionen synthetischer Hochpolymerer, F. Hölscher, Springer-Verlag, Berlin (1969)]. The free-radically induced aqueous emulsion polymerization reactions typically take place by the ethylenically unsaturated monomers being dispersed, using dispersing assistants, in the aqueous medium in the form of monomer droplets and being polymerized by means of a free-radical polymerization initiator. The present process differs from this procedure in particular through the specific supplying of ethylenically unsaturated monomers having a crosslinking effect.

For the preparation of aqueous copolymer dispersions using ethylenically unsaturated monomers having a crosslinking effect the relevant prior art includes in particular that detailed in the paragraphs which now follow.

WO 00/55223 discloses the use of ethylenically unsaturated crosslinkers in connection with the preparation of polymer dispersions as binders for metal coatings having a corrosion inhibition effect. The effect of using the crosslinkers is that the discrete spherical particles of the copolymer dispersion are dimensionally stable. The ethylenically unsaturated crosslinkers are used in fractions of 0.1 to 6% by weight and are added continuously during the emulsion polymerization.

GB-A 1389115 discloses the use of ethylenically unsaturated crosslinkers in connection with the preparation of graft copolymers for use as additives for reinforcing PVC and nitrile rubber. The graft copolymers comprise a core containing 0.1 to 1% by weight of crosslinker in copolymerized form, and a crosslinker-free graft shell.

A particular disadvantage of the aqueous copolymer dispersions obtainable in accordance with the prior art is their high level of coagulum. Moreover, the spray-drying of these aqueous copolymer dispersions is accompanied by increased wall deposits in the spraying tower, which has an adverse effect on the powder yield and which increases the cleaning effort required.

It was an object of the present invention to provide a new process for preparing aqueous dispersions of crosslinked copolymers that is distinguished by lower levels of coagulum.

Surprisingly, this object has been achieved by the process defined at the outset.

This process of the invention takes place semibatchwise in a polymerization vessel—that is, any vessel in which an aqueous emulsion polymerization can be implemented. Examples of polymerization vessels comprise, in particular, glass reactors, enameled steel reactors or stainless steel reactors whose size can be from 0.5 l to 100 m³.

Suitable monomers A include, in particular, ethylenically unsaturated monomers which are easy to polymerize free-radically, such as for example, ethylene, vinylaromatic monomers such as styrene, α-methylstyrene, o-chlorostyrene or vinyltoluenes, esters of vinyl alcohol and monocarboxylic acids having 1 to 18 C atoms such as vinyl acetate, vinyl propionate, vinyl-n-butyrate, vinyl laurate and vinyl stearate, esters of α,β-monoethylenically unsaturated monocarboxylic and dicarboxylic acids containing preferably 3 to 6 C atoms, such as, in particular, acrylic acid, methacrylic acid, maleic acid, fumaric acid and itaconic acid, with alkanols containing generally 1 to 12, preferably 1 to 8, and in particular 1 to 4 C atoms such as, particularly, methyl, ethyl, n-butyl, isobutyl and 2-ethylhexyl acrylates and methacrylates, dimethyl maleate or di-n-butyl maleate, nitriles of α,βmonoethylenically unsaturated carboxylic acids, such as acrylonitrile, and C₄₋₈ conjugated dienes, such as 1,3-butadiene and isoprene. These monomers generally form the principal monomers, which, based on the total amount of the monomers A to be polymerized by the process of the invention, normally account for a fraction of ≧50% by weight, ≧80% by weight or ≧90% by weight. As a general rule these monomers are only of moderate to low solubility in water under standard conditions [20° C., 1 atm=1.013 bar (absolute)].

Further monomers A, which typically increase the internal strength of the films formed from the polymer matrix, normally contain at least one hydroxyl, N-methylol or carbonyl group. Of particular importance in this context are the C₁-C₈ hydroxyalkyl esters of acrylic and methacrylic acid, such as n-hydroxyethyl, n-hydroxypropyl or n-hydroxybutyl acrylate and methacrylate, and also compounds such as diacetoneacrylamide and acetylacetoxyethyl acrylate and methacrylate. In accordance with the invention the aforementioned monomers, based on the total amount of monomers A to be polymerized, are used for the polymerization in amounts of ≦5%, often ≧0.1% and ≦3% and frequently ≧0.2% and ≦2% by weight.

Also suitable for use as monomers A are ethylenically unsaturated monomers comprising siloxane groups, such as the vinyltrialkoxysilanes, vinyltrimethoxysilane, for example, alkylvinyldialkoxysilanes, acryloyloxyalkyltrialkoxysilanes, or methacryloyloxyalkyltrialkoxysilanes, such as acryloyloxyethyltrimethoxysilane, methacryloyloxyethyltrimethoxysilane, acryloyloxypropyltrimethoxysilane or methacryloyloxypropyltrimethoxysilane, for example. These monomers are used in total amounts of ≦5%, frequently of ≧0.01 and ≦3% and often of ≧0.05% and ≦1% by weight, based in each case on the total amount of monomers A.

In addition it is possible to use as monomers A, besides the above, those ethylenically unsaturated monomers AS which comprise at least one acid group and/or its corresponding anion, or those ethylenically unsaturated monomers AK which comprise at least one amino, amido, ureido or N-heterocyclic group and/or their ammonium derivatives alkylated or protonated on the nitrogen. Based on the total amount of the monomers A to be polymerized, the amount of monomers AS and/or monomers AK is ≦10%, often ≧0.1% and ≦7%, and frequently ≧0.2% and ≦5% by weight.

Monomers AS used are ethylenically unsaturated monomers containing at least one acid group. This acid group may be, for example, a sulfonic, a sulfuric, phosphoric and/or phosphonic acid group. Examples of such monomers AS are 4-styrenesulfonic acid, 2-methacryloyloxyethylsulfonic acid, vinylsulfonic acid and vinylphosphonic acid, and also phosphoric monoesters of n-hydroxyalkyl acrylates and n-hydroxyalkyl methacrylates, such as, for example, phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate. In accordance with the invention, it is also possible, however, to use the ammonium salts and alkali metal salts of the aforementioned ethylenically unsaturated monomers containing at least one acid group. As an alkali metal, particular preference is attached to sodium and potassium. Examples of such are the ammonium, sodium, and potassium salts of 4-styrenesulfonic acid, 2-methacryloyloxyethylsulfonic acid, vinylsulfonic acid and vinylphosphonic acid, and also the mono- and di-ammonium, -sodium and -potassium salts of the phosphoric monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Preference is given to using 4-styrenesulfonic acid, 2-methacryloyloxyethylsulfonic acid, vinylsulfonic acid, and vinylphosphonic acid as monomers AS.

Monomers AK used are ethylenically unsaturated monomers which comprise at least one amino, amido, ureido or N-heterocyclic group and/or their ammonium derivatives alkylated or protonated on the nitrogen.

Examples of monomers AK which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methylamino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (available commercially for example as Norsocryl® TBAEMA from Elf Atochem), 2-(N,N-dimethylamino)ethyl acrylate (available commercially for example as Norsocryl® ADAME from Elf Atochem), 2-(N,N-dimethylamino)ethyl methacrylate (available commercially for example as Norsocryl® MADAME from Elf Atochem), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-isopropylamino)propyl acrylate, 3-(N-isopropylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-diisopropylamino)propyl acrylate and 3-(N,N-diisopropylamino)propyl methacrylate.

Examples of monomers AK which comprise at least one amido group are N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-diisopropylacrylamide, N,N-diisopropylmethacrylamide, N,N-di-n-butylacrylamide, N,N-di-n-butylmethacrylamide, N-(3-N′,N′-dimethylaminopropyl)methacrylamide, diacetoneacrylamide, N,N′-methylenebisacrylamide, N-(diphenylmethyl)acrylamide, N-cyclohexylacrylamide, and also N-vinylpyrrolidone and N-vinylcaprolactam.

Examples of monomers AK which comprise at least one ureido group are N,N′-divinylethyleneurea and 2-(1-imidazolin-2-onyl)ethyl methacrylate (available commercially for example as Norsocryl® 100 from Elf Atochem).

Examples of monomers AK which comprise at least one N-heterocyclic group are 2-vinylpyridine, 4-vinylpyridine, 1-vinylimidazole, 2-vinylimidazole and N-vinylcarbazole.

As monomers AK it is preferred to use the following compounds: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, and 2-(1-imidazolin-2-onyl)ethyl methacrylate.

Depending on the pH of the aqueous reaction medium it is possible for some or all of the aforementioned nitrogen-containing monomers AK to be in the quaternary ammonium form protonated on the nitrogen.

Examples of monomers AK which have a quaternary alkylammonium structure on the nitrogen include 2-(N,N,N-trimethylammonium)ethyl acrylate chloride (available commercially for example as Norsocryl® ADAMQUAT MC 80 from Elf Atochem), 2-(N,N,N-trimethylammonium)ethyl methacrylate chloride (available commercially for example as Norsocryl® MADQUAT MC 75 from Elf Atochem), 2-(N-methyl-N,N-diethylammonium)ethyl acrylate chloride, 2-(N-methyl-N,N-diethylammonium)ethyl methacrylate chloride, 2-(N-Methyl-N,N-dipropylammonium)ethyl acrylate chloride, 2-(N-methyl-N,N-dipropylammonium)ethyl methacrylate, 2-(N-benzyl-N,N-dimethylammonium)ethyl acrylate chloride (available commercially for example as Norsocryl® ADAMQUAT BZ 80 from Elf Atochem), 2-(N-benzyl-N,N-dimethylammonium)ethyl methacrylate chloride (available commercially for example as Norsocryl® MADQUAT BZ 75 from Elf Atochem), 2-(N-benzyl-N,N-diethylammonium)ethyl acrylate chloride, 2-(N-benzyl-N,N-diethylammonium)ethyl methacrylate chloride, 2-(N-benzyl-N,N-dipropylammonium)ethyl acrylate chloride, 2-(N-benzyl-N,N-dipropylammonium)ethyl methacrylate chloride, 3-(N,N,N-trimethyl ammonium)propyl acrylate chloride, 3-(N,N,N-trimethylammonium)propyl methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropylammonium)propyl acrylate chloride, 3-(N-methyl-N,N-dipropylammonium)propyl methacrylate chloride, 3-(N-benzyl-N,N-dimethylammonium)propyl acrylate chloride, 3-(N-benzyl-N,N-dimethylammonium)propyl methacrylate chloride, 3-(N-benzyl-N,N-diethylammonium)propyl acrylate chloride, 3-(N-benzyl-N,N-diethylammonium)propyl methacrylate chloride, 3-(N-benzyl-N,N-dipropylammonium)propyl acrylate chloride and 3-(N-benzyl-N,N-dipropylammonium)propyl methacrylate chloride. In place of the chlorides listed it is of course also possible to use the corresponding bromides and sulfates.

Preference is given to using 2-(N,N,N-trimethylammonium)ethyl acrylate chloride, 2-(N,N,N-trimethylammonium)ethyl methacrylate chloride, 2-(N-benzyl-N,N-dimethylammonium)ethyl acrylate chloride and 2-(N-benzyl-N,N-dimethylammonium)ethyl methacrylate chloride.

It is of course also possible to use mixtures of the aforementioned ethylenically unsaturated monomers A.

The total amount of the monomers A is 70% to 99.5%, advantageously 80% to 99%, and with particular advantage 90% to 98% by weight, based in each case on the total monomer amount.

In accordance with the invention it is possible for a portion, if appropriate, of the monomers A to be included in the initial charge to the polymerization vessel and for the total amount or, if appropriate, remainder of monomers A to be metered into the polymerization vessel under polymerization conditions, discontinuously in two or more portions or continuously with constant or varying flow rates. With advantage ≦30% and with particular advantage ≦10% by weight of the monomers A is included in the initial charge to the polymerization vessel and the total amount or remainder of monomers A is metered into the polymerization vessel continuously with constant or varying flow rates.

Monomers B used are compounds containing at least two free-radically copolymerizable ethylenically unsaturated groups. Examples of such are monomers containing at least two vinyl radicals, monomers containing at least two vinylidene radicals and monomers containing at least two alkenyl radicals. Of particular advantage in this context are the diesters of dihydric alcohols with α,β-monoethylenically unsaturated monocarboxylic acids, among which acrylic and methacrylic acid are preferred. Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and also o-, m- and/or p-divinylbenzene, vinyl methacrylate, vinyl acrylate, allyl methacrylate, allyl acrylate, diallyl maleate, diallyl fumarate, diallyl phthalate, methylenebisacrylamide, cyclopentadienyl acrylate, triallyl cyanurate or triallyl isocyanurate.

It is of course also possible to use mixtures of the aforementioned monomers B.

Use is made advantageously of o-/m-/p-divinylbenzene, 1,4-butylene glycol diacrylate, vinyl acrylate, vinyl methacrylate, allyl acrylate and/or allyl methacrylate as monomers B.

The total amount of the monomers B is 0.5 to 30%, advantageously 1 to 20%, and with particular advantage 2 to 10% by weight, based in each case on the total monomer amount.

In accordance with the invention it is possible for a portion, if appropriate, of the monomers B to be included in the initial charge to the polymerization vessel and for the total amount or, if appropriate, remainder of monomers B to be metered into the polymerization vessel under polymerization conditions, discontinuously in two or more portions or continuously with constant or varying flow rates. With advantage ≦10% and with particular advantage ≦5% by weight of the monomers B is included in the initial charge to the polymerization vessel and the total amount or remainder of monomers B is metered into the polymerization vessel.

Monomers C used are α,β-monoethylenically unsaturated monocarboxylic or dicarboxylic acids containing 3 to 6 C atoms, and/or their amides. Examples of such are acrylic acid, methacrylic acid, maleic acid, fumaric acid, itaconic acid, crotonic acid and their corresponding amides. In accordance with the invention, however, it is also possible to use the ammonium salts and alkali metal salts of the aforementioned ethylenically unsaturated monocarboxylic or dicarboxylic acids. Particularly preferred alkali metals are sodium and potassium. Examples thereof are the ammonium, sodium, and potassium salts of acrylic acid, methacrylic acid, maleic acid, fumaric acid, itaconic acid, and crotonic acid.

It is of course also possible to use mixtures of the aforementioned monomers C.

Use is made advantageously of acrylic acid, methacrylic acid, itaconic acid, acrylamide and/or methacrylamide as monomers C.

The total amount of the monomers C is generally ≦5%, often ≧0.1% and ≦3%, and frequently ≧0.2% and ≦2%, by weight, based in each case on the total monomer amount.

In accordance with the invention it is possible for a portion, if appropriate, of the monomers C to be included in the initial charge to the polymerization vessel and for the total amount or, if appropriate, remainder of monomers C to be metered into the polymerization vessel under polymerization conditions, discontinuously in two or more portions or continuously with constant or varying flow rates. With advantage ≦30% and with particular advantage ≦10% by weight of the monomers C is included in the initial charge to the polymerization vessel and the total amount or remainder of monomers C is metered into the polymerization vessel continuously with constant or varying flow rates.

With particular advantage the monomers A to C are selected such that ≧95% and with particular advantage ≧97% by weight of all monomers have a solubility in deionized water at 20° C. and 1 atm (absolute) of ≦10% and in particular ≦5% by weight.

With advantage, the type and amount of the monomers A and of monomers C are selected such that a copolymer synthesized solely from these monomers would have a glass transition temperature of ≧40° C., advantageously ≧70° C. and with particular advantage ≧90° C.

The glass transition temperature is typically determined in accordance with DIN 53 765 (Differential Scanning Calorimetry, 20 K/min, midpoint measurement).

According to Fox (T. G. Fox, Bull. Am. Phys. Soc. 1956 [Ser. II] 1, page 123 and according to Ullmann's Encyclopädie der technischen Chemie, vol. 19, page 18, 4th edition, Verlag Chemie, Weinheim, 1980) the glass transition temperature T_{g} of copolymers with no more than low levels of crosslinking is given in good approximation by:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures, in degrees Kelvin, of the polymers synthesized in each case only from one of the monomers 1, 2, . . . n. The T_{g} values for the homopolymers of the majority of monomers are known and listed, for example, in Ullmann's Encyclopedia of Industrial Chemistry, 5th ed., vol. A21, page 169, Verlag Chemie, Weinheim, 1992; other sources of homopolymer glass transition temperatures include for example J. Brandrup, E. H. Immergut, Polymer Handbook, 1^{st} ed., J. Wiley, New York, 1966; 2^{nd} ed. J. Wiley, New York, 1975 and 3^{rd} ed. J. Wiley, New York, 1989.

The present process of the invention uses water, preferably drinking-grade water and more preferably deionized water, whose total amount is such that it is 30% to 90% and advantageously 50% to 80% by weight, based in each case on the aqueous copolymer dispersion obtainable through the process of the invention.

In accordance with the invention it is possible to include, if appropriate, a portion or the total amount of water in the initial charge to the polymerization vessel. It is also possible, however, to meter in the total amount or, if appropriate, the remainder of water together with the monomers A, B and/or C, in particular in the form of an aqueous monomer emulsion. With advantage a small portion of water is included in the initial charge to the polymerization vessel and a larger portion of water is metered in as an aqueous monomer emulsion under polymerization conditions.

In the context of the present invention use is made also of dispersants, which may keep not only the monomer droplets but also the resultant copolymer particles in dispersion in the aqueous phase and thus ensure the stability of the aqueous copolymer dispersion produced. Suitable such dispersants include not only the protective colloids, which are typically used for implementing free-radical aqueous emulsion polymerizations, but also emulsifiers.

Examples of suitable protective colloids are polyvinyl alcohols, cellulose derivatives or vinylpyrrolidone copolymers. An exhaustive description of further suitable protective colloids is found in Houben-Weyl, Methoden der organischen Chemie, volume XIV/1, Makromolekulare Stoffe [Macromolecular compounds], pages 411 to 420, Georg-Thieme-Verlag, Stuttgart, 1961.

It will be appreciated that mixtures of emulsifiers and/or protective colloids can be used as well. Dispersants used frequently comprise exclusively emulsifiers, whose relative molecular weights, unlike those of the protective colloids, are typically below 1000 g/mol. They may be anionic, cationic or nonionic in nature. Where mixtures of surface-active substances are used, the individual components must of course be compatible with one another, something which in case of doubt can be ascertained by means of a few preliminary tests. Generally speaking, anionic emulsifiers are compatible with one another and with nonionic emulsifiers. The same is true of cationic emulsifiers, whereas anionic and cationic emulsifiers are usually not compatible with one another.

Customary emulsifiers are, for example ethoxylated mono-, di- and tri-alkylphenols (EO degree: 3 to 50, alkyl radical: C₄ to C₁₂), ethoxylated fatty alcohols (EO degree: 3 to 50; alkyl radical: C₈ to C₃₆), and alkali metal salts and ammonium salts of alkyl sulfates (alkyl radical: C₈ to C₁₂), of sulfuric monoesters with ethoxylated alkanols (EO degree: 4 to 30, alkyl radical: C₁₂ to C₁₈) and ethoxylated alkylphenols (EO degree: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈). Further suitable emulsifiers are found in Houben-Weyl, Methoden der organischen Chemie, volume XIV/1, Makromolekulare Stoffe, pages 192 to 208, Georg-Thieme-Verlag, Stuttgart, 1961.

Compounds which have also proven appropriate surface-active substances include those of the general formula I

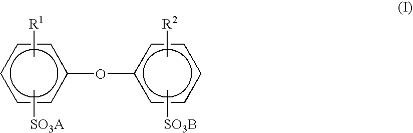

in which R¹ and R² can be C₄ to C₂₄ alkyl and where one of the radicals R¹ or R² can also be hydrogen, and A and B can be alkali metal ions and/or ammonium ions. In the general formula I, R¹ and R² are preferably linear or branched alkyl radicals of 6 to 18 C atoms, having in particular 6, 12 and 16 C atoms or H atoms, with R¹ and R² not both simultaneously being H atoms. A and B are preferably sodium, potassium or ammonium ions, sodium ions being particularly preferred. Particularly advantageous compounds I are those in which A and B are sodium ions, R¹ is a branched alkyl radical with 12 C atoms and R² is an H atom or R¹. Use is made frequently of technical mixtures containing a fraction of 50% to 90% by weight of the monoalkylated product, an example being Dowfax® 2A1 (brand of the Dow Chemical Company). The compounds I are general knowledge, from U.S. Pat. No. 4,269,749, for example, and are available commercially.

For the process of the invention it is preferred to use nonionic and/or anionic emulsifiers. It is also possible, however, to use cationic emulsifiers. Particular preference is given to using anionic emulsifiers such as alkylarylsulfonic acids, alkyl sulfates, sulfuric monoesters with ethoxylated alkanols and/or their corresponding alkali metal salts.

In general the amount of dispersant used is ≧0.1 and ≦15% and preferably ≧0.5 to ≦5% by weight, based in each case on the total monomer amount.

In accordance with the invention it is possible to include, if appropriate, a portion or the total amount of dispersant in the initial charge to the polymerization vessel. An alternative option, though, is to meter in the total amount or, if appropriate, remainder of dispersant together with the monomers A, B, and/or C, particularly in the form of an aqueous monomer emulsion, under polymerization conditions.

The initiation of the free-radically initiated aqueous emulsion polymerization is effected by means of a free-radical polymerization initiator (free-radical initiator). This initiator may in principle encompass not only peroxides but also azo compounds. Redox initiator systems are of course also suitable. Peroxides used may in principle be inorganic peroxides, such as hydrogen peroxide or peroxodisulfates, such as the mono- or di-alkali metal or ammonium salts of peroxodisulfuric acid, such as, for example, its mono- and di-sodium, -potassium or -ammonium salts or organic peroxides, such as alkyl hydroperoxides, examples being tert-butyl, p-menthyl or cumyl hydroperoxide, and also dialkyl or diaryl peroxides, such as di-tert-butyl peroxide or dicumyl peroxide. As an azo compound, use is made substantially of 2,2′-azobis(isobutyronitrile), 2,2′-azobis(2,4-dimethylvaleronitrile) and 2,2′-azobis(amidinopropyl) dihydrochloride (AIBA, corresponding to V-50 from Wako Chemicals). Suitable oxidizing agents for redox initiator systems are essentially the abovementioned peroxides. As corresponding reducing agents it is possible to use compounds of sulfur having a low oxidation state, such as alkali metal sulfites, for example potassium and/or sodium sulfite, alkali metal hydrogen sulfites, for example, potassium and/or sodium hydrogen sulfite, alkali metabisulfites, for example potassium and/or sodium metabisulfite, formaldehyde sulfoxylates, for example potassium and/or sodium formaldehyde sulfoxylate, alkali metal salts, especially potassium and/or sodium salts, of aliphatic sulfinic acids, and alkali metal hydrogen sulfides, such as potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid and also reducing saccharides, such as sorbose, glucose, fructose and/or dihydroxyacetone. In general the amount of free-radical initiator used, based on the total monomer amount, is 0.01% to 5%, preferably 0.1 to 3%, and with particular preference 0.2% to 1.5%, by weight.

In accordance with the invention, it is possible to include if appropriate a portion or the total amount of free-radical initiator in the initial charge to the polymerization vessel. An alternative option is to meter in the total amount or if appropriate, remainder of free-radical initiator to the polymerization vessel under polymerization conditions.

In accordance with the invention it is also possible to use further, optional auxiliaries familiar to the skilled workers, such as, for example, what are called thickeners, defoamers, neutralizing agents, preservatives, free-radical chain transfer compounds and/or complexing agents.

In order to tailor the rheology of the aqueous copolymer dispersions that are obtainable in accordance with the invention, in the course of preparation, handling, storage and application, it is common to use what are called thickeners or rheological additives as a formulating ingredient. The skilled person is aware of a large number of different thickeners, examples being organic thickeners, such as xanthan thickeners, guar thickeners (polysaccharides), carboxymethylcellulose, hydroxyethylcellulose, methylcellulose, hydroxypropylmethylcellulose, and ethylhydroxyethylcellulose (cellulose derivates), alkali-swellable dispersions (acrylate thickeners) or hydrophobically modified, polyether-based polyurethanes (polyurethane thickeners) or inorganic thickeners, such as bentonite, hectorite, smectite, attapulgite (Bentone) and also titanates or zirconates (metal organyls).

In order to prevent the formation of foam during preparation, handling, storage and application of the aqueous copolymer dispersions that are obtainable in accordance with the invention, use is made of what are called defoamers. The defoamers are familiar to the skilled worker. They are, essentially, mineral oil defoamers and silicone oil defoamers. Defoamers, especially the highly active silicone-containing varieties, must generally be selected very carefully and metered very carefully, since they can lead to surface defects (craters, dimples, etc.) in the coating. It is important that, through addition of very finely divided hydrophobic particles, such as hydrophobic silica or wax particles, to the defoamer liquid, the defoamer effect can be increased further.

If necessary, acids or bases familiar to the skilled worker as neutralizing agents can be used to adjust the pH of the aqueous polymer dispersions that are obtainable in accordance with the invention.

In order to avoid infestation by microorganisms of the aqueous copolymer dispersions that are obtainable in accordance with the invention, in the course of preparation, handling, storage, and application, examples of such microorganisms being bacteria, molds, fungi or yeasts, it is common to use biocides or preservatives that are familiar to the skilled worker. Used particularly in this context are active-ingredient combinations of methyl- and chloroisothiazolinones, benzisothiazolinones, formaldehyde and formaldehyde donors.

In the process of the invention for preparing the aqueous copolymer dispersions it is optionally possible, in addition to the aforementioned components, to use free-radical chain transfer compounds as well, in order to reduce or control the molecular weight of the copolymers available through the polymerization. Compounds employed in this context are, essentially, aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide; organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methylbenzenethiol, and also all further sulfur compounds described in Polymer Handbook, 3^{rd} edition, 1989, J. Brandrup and E. H. Immergut, John Wiley & Sons, section II, pages 133 to 141; and also aliphatic and/or aromatic aldehydes, such as acetaldehyde, propionaldehyde and/or benzaldehyde; unsaturated fatty acids, such as oleic acid; dienes containing nonconjugated double bonds, such as divinylmethane or vinylcyclohexane; or hydrocarbons containing readily abstractable hydrogen atoms, such as toluene, for example. It is advantageous to use tert-dodecyl mercaptan, 2,4-diphenyl-4-methyl-1-pentene and terpinolene (see, for example, DE-A 10046930 or DE-A 10148511).

The total amount of the further optional auxiliaries, based on the total monomer amount, is generally ≦10%, ≦5%, often ≦3%, and frequently ≦2% by weight.

In accordance with the invention it is possible to include, if appropriate, portions or total amounts of further optional auxiliaries in the initial charge to the polymerization vessel. It is also possible, however, to meter total amounts or any remainders of further optional auxiliaries in under polymerization conditions, if appropriate as a constituent of the monomer mixture and/or of the aqueous monomer emulsion comprising said mixture.

Optionally the free-radically initiated aqueous emulsion polymerization of the invention can also take place in the presence of a polymer seed, in the presence for example of 0.01 to 10%, frequently of 0.01% to 5% and often of 0.04% to 3.5% by weight of a polymer seed, based in each case on the total monomer amount.

A polymer seed is used particularly when the particle size of the polymer particles to be prepared by means of free-radical aqueous emulsion polymerization is to be set in a controlled way (in this regard see, for example, U.S. Pat. No. 2,520,959 and U.S. Pat. No. 3,397,165).

Use is made in particular of polymer seed whose particles have a narrow size distribution and weight-average diameters D_{w}≦100 nm, frequently ≧5 nm to ≦50 nm and often ≧15 nm to ≦35 nm. Determination of the weight-average particle diameters is known to the skilled worker and is accomplished, for example, via the method of the analytical ultracentrifuge. By weight-average particle diameter in this specification is meant the weight-average D_{w50} value determined by the method of the analytical ultracentrifuge (cf. in this regard S. E. Harding et al., Analytical Ultracentrifugation in Biochemistry and Polymer Science, Royal Society of Chemistry, Cambridge, Great Britain 1992, chapter 10, Analysis of Polymer Dispersions with an Eight-Cell AUC Multiplexer: High Resolution Particle Size Distribution and Density Gradient Techniques, W. Mächtle, pages 147 to 175).

A particle size distribution is considered narrow for the purposes of this specification when the ratio of the weight-average particle diameter D_{w50} to the number-average particle diameter Dₙ₅₀ [D_{w50}/Dₙ₅₀] as determined by the method of the analytical ultracentrifuge is ≦2.0, preferably ≦1.5 and more preferably ≦1.2 or ≦1.1.

The polymer seed is typically used in the form of an aqueous polymer dispersion. The aforementioned quantities refer to the polymer solids fraction of the aqueous polymer seed dispersion; they are therefore specified as parts by weight of polymer seed solids, based on the total monomer amount.

Where a polymer seed is used it is advantageous to employ an exogenous polymer seed. Unlike an in situ polymer seed, which is prepared in the reaction vessel before the actual emulsion polymerization is commenced, and which has the same monomeric composition as the polymer prepared by the subsequent free-radically initiated aqueous emulsion polymerization, an exogenous polymer seed is a polymer seed which has been prepared in a separate reaction step and whose monomeric composition differs from that of the polymer prepared by the free-radically initiated aqueous emulsion polymerization, although this means nothing more than that different monomers, or monomer mixtures with a different composition, are used for preparing the exogenous polymer seed and for preparing the aqueous polymer dispersion. The preparation of an exogenous polymer seed is familiar to the skilled worker and is typically accomplished by the introduction and initial charge to a reaction vessel of a relatively small amount of monomers and also a relatively large amount of emulsifiers, and by the addition at reaction temperature of a sufficient amount of polymerization initiator.

It is preferred in accordance with the invention to use an exogenous polymer seed having a glass transition temperature ≧50° C., frequently ≧60° C. or ≧70° C. and often ≧80° C. or ≧90° C. A polystyrene or polymethyl methacrylate polymer seed is particularly preferred.

In accordance with the invention it is possible to include if appropriate a portion or the total amount of exogenous polymer seed as a further optional auxiliary in the initial charge to the polymerization vessel. It is also possible, however, to meter in the total amount or any remainders of exogenous polymer seed under polymerization conditions.

By polymerization conditions are meant those temperatures and pressures at which the free-radically initiated aqueous emulsion polymerization proceeds at a sufficient polymerization rate. This is dependent in particular, however, on the free-radical initiator used. Advantageously, the nature and amount of the free-radical initiator, the polymerization temperature and the polymerization pressure are selected such that the free-radical initiator has a half life ≦3 hours, with particular advantage ≦1 hour and with very particular advantage ≦30 minutes.

Depending on the free-radical initiator chosen a suitable reaction temperature for the free-radical aqueous emulsion polymerization of the invention is the entire range from 0 to 170° C. It is usual to employ temperatures here of 50 to 150° C., in particular 60 to 130° C. and advantageously 70 to 120° C. The free-radical aqueous emulsion polymerization of the invention can be carried out under a pressure of less than, equal to or greater than 1 atm, so that the polymerization temperature may exceed 100° C. and can be up to 170° C. In the presence of volatile monomers, such as ethylene, butadiene or vinyl chloride for example, it is preferred to carry out polymerization under elevated pressure. In that case the pressure may adopt 1.2, 1.5, 2, 5, 10, 15 bar (absolute) or even higher values. Where emulsion polymerizations are carried out under subatmospheric pressure, pressures of 950 mbar are set, frequently 900 mbar and often 850 mbar (absolute). With advantage the free-radical aqueous emulsion polymerization of the invention is carried out at elevated pressure under an inert gas atmosphere, such as under nitrogen or argon, for example.

In general the process of the invention takes place by the initial charging to the polymerization vessel at 20 to 25° C. (room temperature) under an inert gas atmosphere of a portion of the deionized water, of the dispersant and, if appropriate, a portion of the monomers A, B and/or C and the free-radical initiator, followed by the heating of the initial charge mixture to the appropriate polymerization temperature, with stirring, and subsequently by the metered addition of the remaining amounts of deionized water and dispersing assistant and also of the total amounts or any remainders of monomers A, B and/or C and also free-radical initiator. The metering of the monomers A, B and/or C, of the free-radical initiator and of the other components may take place discontinuously in a plurality of portions, and also continuously, with constant or varying flow rates.

In a further preferred embodiment, the monomers A to C are metered in the form of two monomer emulsions, the first monomer emulsion (monomer emulsion 1) comprising ≧60% by weight of the total monomer amount, but ≦40% by weight of the total amount of the monomers B, while the second monomer emulsion (monomer emulsion 2) comprises ≦40% by weight of the total monomer amount, but ≧60% by weight of the total amount of the monomers B. In this case the process of the invention takes place by the supplying first of monomer emulsion 1 and subsequently of monomer emulsion 2 to the polymerization vessel under polymerization conditions. In accordance with the invention it is possible in this case for a portion, if appropriate, of the monomer emulsion 1 to be included in the initial charge to the polymerization vessel and for the total amount or any remainder of the monomer emulsion 1 to be metered into the polymerization vessel under polymerization conditions discontinuously in two or more portions or continuously with constant or varying flow rates. Subsequent to this, the monomer emulsion 2 is metered into the polymerization vessel under polymerization conditions, discontinuously in two or more portions, or continuously, with constant or varying flow rates. It is preferred to meter monomer emulsions 1 and 2 continuously with constant flow rates.

Reaction regime and the choice of reaction conditions are preferably made such that, after the free-radical polymerization reaction has been initiated, the monomers A to C and the free-radical initiator are supplied to the polymerization mixture in the polymerization vessel in such a way that at any given point in time the monomer conversion is ≧80%, advantageously ≧90% and of particular advantage ≧95% by weight, based on the total amount of the monomers supplied to the polymerization mixture at that point in time, something which can be verified easily by means of reaction calorimetry measurements, which are familiar to the skilled worker.

In the process of the invention, it is also possible in principle for small amounts (≦10% by weight, based on the total water amount) of water-soluble organic solvents to be used, such as methanol, ethanol, isopropanol, butanols, pentanols and also acetone, etc. With preference, however, the process of the invention is conducted in the absence of such solvents.

The reaction regime in the process of the invention is advantageously such that ≧60% and ≦95%, preferably ≧60% and ≦90%, and with particular preference ≧70% and ≦90%, by weight of the total amount of monomers B is metered into the polymerization mixture under polymerization conditions after ≧70%, preferably ≧75% and with particular preference ≧80%, by weight of the total monomer amount has been metered into the polymerization mixture under polymerization conditions.

The aqueous copolymer dispersions obtained by the process of the invention typically have a copolymer solids content of ≧10% and ≦70%, frequently ≧20% and ≦65%, and often ≧40% and ≦60%, by weight, based in each case on the aqueous copolymer dispersion. The number-average particle diameter as determined by quasi-elastic light scattering (ISO Standard 13 321; cumulant z-average) is in general between 10 and 2000 nm, frequently between 20 and 300 nm and often between 30 and 200 nm.

In the case of the aqueous copolymer dispersions obtained in accordance with the invention, it will be appreciated that the remaining, residual amounts of unreacted monomers A to C and also of other low-boiling compounds can be lowered by means of chemical and/or physical methods familiar to the skilled worker [see, for example, EP-A 771328, DE-A 19624299, DE-A 19621027, DE-A 19741184, DE-A 19741187, DE-A 19805122, DE-A 19828183, DE-A 19839199, DE-A 19840586 and 19847115].

Furthermore, the aqueous copolymer dispersions obtainable by the process of the invention can be used as a component in the production of adhesives, sealants, polymer renders, paper coating slips, nonwovens, paints, and coating materials for organic substrates, and also for modifying mineral binders.

In addition, from the aqueous copolymer dispersions of the invention, the corresponding copolymer powders are obtainable easily (by freeze drying or spray drying, for example). In this context, the aqueous polymer dispersions of the invention are especially suitable for spray drying and in that case, even without further spraying assistants, feature high powder yields in conjunction with a low caking tendency. The copolymer powders obtainable in accordance with the invention can likewise be used with advantage as a component in the production of adhesives, sealants, polymer renders, paper coating slips, nonwovens, paints, and coating materials for organic substrates, and also for modifying mineral binders.

The following, nonlimiting examples are intended to explain the invention.

A) Preparation of Aqueous Copolymer Dispersions

Copolymer Dispersion D1

A 5 l pressure reactor equipped with a MIG stirrer and 4 metering devices was charged at room temperature under nitrogen with 1280 g of deionized water and 40 g of a 15% strength by weight aqueous sodium dodecyl sulfate solution. The contents of the reactor were subsequently heated to 95° C. with stirring and 97 g of a 3% strength by weight aqueous ammonium persulfate solution was added. Thereafter, beginning simultaneously, the total amount of feed 1A over the course of 80 minutes, and feed 2 over the course of 95 minutes, were metered in continuously with constant flow rates.

Directly after the end of feed 1A, feed 1B was commenced and was metered in over the course of 15 minutes continuously with constant flow rates. Subsequently the contents of the reactor were allowed to react at 95° C. for 5 hours. After that the contents of the reactor were cooled to room temperature and the pressure vessel was let down to atmospheric pressure. The coagulant formed was separated from the dispersion by filtration on a sieve (mesh size: 100 micrometers) and was weighed after drying.

Feed 1A
homogeneous emulsion of

| | | |
|---|---|---|
| 360 | g | deionized water |
| 80 | g | 15% strength by weight aqueous |
| | | sodium dodecyl sulfate solution |
| 300 | g | n-butyl acrylate |
| 597.5 | g | styrene |
| 2.5 | g | 1,4-butylene glycol diacrylate |

Feed 1B
homogeneous emulsion of

| | | |
|---|---|---|
| 90 | g | deionized water |
| 13.3 | g | 15% strength by weight aqueous |
| | | sodium dodecyl sulfate solution |
| 27.5 | g | n-butyl acrylate |
| 55 | g | styrene |
| 17.5 | g | 1,4-butylene glycol diacrylate |

Feed 2

| | | |
|---|---|---|
| 58 | g | 8.6% strength by weight aqueous |
| | | ammonium persulfate solution |

The resultant aqueous copolymerization dispersion D1 had a solids content of 33.4% by weight, based on the total weight of the aqueous dispersion. The amount of coagulant was 6 g. The glass transition temperature was found to be 44° C. and the particle size 62 nm.

The solids contents were determined in general by drying a defined amount of the respective aqueous copolymer dispersion (approximately 5 g) to a constant weight in a drying cabinet at 140° C. Two separate measurements were carried out in each case. The figures reported in the examples represent the average of these two measurement results.

The glass transition temperature was determined in accordance with DIN 53765 using a DSC820 instrument, Series TA8000 from Mettler-Toledo Int. Inc.

The average diameters of the polymer particles were determined by dynamic light scattering on a 0.005% to 0.01% by weight aqueous polymer dispersion at 23° C., using an Autosizer IIC from Malvern Instruments, England. The figure reported is the average diameter of the cumulant evaluation (cumulant z-average) of the measured autocorrelation function (ISO Standard 13321).

Comparative Dispersion CD

The comparative dispersion CD, was prepared in the same way as the inventive copolymer dispersion D1, with the difference that feeds 1A and 1B were combined to form a feed 1, which was metered in at constant flow rate over the course of 95 minutes.

The resulting aqueous copolymer dispersion CD had a solids content of 33.5% by weight, based on the total weight of the aqueous dispersion. The amount of coagulant was 24 g. The glass transition temperature was found to be 44° C. and the particle size 60 nm.

B) Preparation of Spray-Dried Polymer Powders

Spray drying was carried out in a Minor laboratory drier from GEA Wiegand GmbH (NIRO Division) with two-fluid nozzle atomization and powder deposition in a cloth filter. The tower entry temperature of the nitrogen was 130° C., the exit temperature was 60° C. 2 kg of a spray feed per hour were metered in.

The spray feed used was the dispersions D1 and CD, which had been diluted beforehand with deionized water to a solids content of 25% by weight.

Metered in simultaneously with the spray feed, and continuously, was 0.4% by weight of the hydrophobic antiblocking agent Sipernat® D 17, based on the solids content of the spray feed, which was introduced into the top of the spraying tower via a weight-controlled twin screw.

The hydrophobic antiblocking agent Sipernat® D 17 from Degussa is a precipitated silica having a specific surface area (in accordance with ISO 5794-1, Annex D) of 100 m²/g, an average particle size (in accordance with ASTM C 690-1992) of 7 micrometers and a tapped density (in accordance with ISO 787-11) of 150 g/l, its surface having been rendered hydrophobic by treatment with specific chlorosilanes.

The wall deposit formed in the spraying tower after the spray drying of inventive copolymer dispersion D1 and of comparative dispersion CD was assessed visually.

The powder yields obtained on spray drying and the assessment of the wall deposits are reported in Table 1 below.

TABLE 1

| Copolymer dispersion | D1 | CD |
|---|---|---|
| Yield on spray drying [% by weight] | 89 | 66 |
| Wall deposit formation | slight | severe |

As is apparent from the results above, the inventive aqueous copolymer dispersion D1 has a much lower quantity of coagulant than the comparative dispersion CD. Additionally, the powder yields achieved with the inventive copolymer dispersion D1 are much higher than those achieved with the comparative dispersion CD.

1. A process for preparing an aqueous copolymer dispersion by free-radically initiated aqueous emulsion polymerization of ethylenically unsaturated monomers in the presence of at least one dispersant and at least one free-radical initiator by the feed method, which comprises using for the emulsion polymerization

| | |
|---|---|
| 70% to 99.5% | α,β-monoethylenically unsaturated compounds |
| by weight | [monomers A], and |
| 0.5 to 30% | compounds having at least two free-radically |
| by weight | copolymerizable ethylenically unsaturated groups |
| | [monomers B], and optionally, |
| up to 5% | α,β-monoethylenically unsaturated monocarboxylic or |
| by weight | dicarboxylic acids having 3 to 6 C atoms and/or their |
| | amides [monomers C], |

the monomers A to C adding up to 100% by weight (total monomer amount) and the monomer feeds being made such that ≧60% by weight of the total amount of monomers B is metered into the polymerization mixture under polymerization conditions at a time when ≧60% by weight of the total monomer amount has been metered in under polymerization conditions to the polymerization mixture.

2. The process according to claim 1, wherein 1% to 20% by weight of monomers B is used.

3. The process according to claim 1, wherein 2% to 10% by weight of monomers B is used.

4. The process according to claim 1, wherein ≧60% by weight and ≦95% by weight of the total amount of monomers B is metered in.

5. The process according to claim 1, wherein ≧60% by weight and ≦90% by weight of the total amount of monomers B is metered in.

6. The process according to claim 1, wherein the monomers B are metered in at a time when ≧70% by weight of the total monomer amount has been metered in under polymerization conditions to the polymerization mixture.

7. The process according to claim 1, wherein the type and amount of monomers A and of monomers C are selected such that a copolymer synthesized solely from these monomers would have a glass transition temperature of ≧40° C.

8. An aqueous copolymer dispersion obtainable by a process according to claim 1.

9. The aqueous copolymer dispersion according to claim 8 for producing adhesives, sealants, polymer renders, paper coating slips, nonwovens, paints or coating materials for organic substrates or for modifying mineral binders.

10. A copolymer powder obtainable by drying an aqueous copolymer dispersion according to claim 8.

11. The copolymer powder according to claim 10 for producing adhesives, sealants, polymer renders, paper coating slips, nonwovens, paints or coating materials for organic substrates or for modifying mineral binders.
